(19) United States
(12) Patent Application Publication
(10) Pub. No.: US 2007/0231781 A1
(43) Pub. Date: Oct. 4, 2007

(54) Estimation of adaptation effort based on metadata similarity

(76) Inventors: Birgit Zimmermann, Frankfurt (DE); Marek Meyer, Schwalbach (DE)

Correspondence Address: BRAKE HUGHES BELLERMANN LLP, C/O INTELLEVATE, P.O. BOX 52050, MINNEAPOLIS, MN, 55402, US

(21) Appl. No.: 11/395,365

(22) Filed: Mar. 31, 2006

(51) Int. Cl. G09B 3/00

(52) U.S. Cl. 434/350

(57) ABSTRACT

First metadata associated with a first e-learning course are read, the first metadata are compared with metadata associated with a desired e-learning course, a dissimilarity between the first course and a desired e-learning course is determined based on a comparison of the first metadata with metadata associated with the desired course, and a cost of transforming the first course into the desired course is determined.

### TECHNICAL FIELD

This description relates to managing electronic content and, in particular, to estimation of the effort required to adapt electronic content based on metadata similarity.

### BACKGROUND

On-line learning tools, courses, and methods have been developed for computer-based delivery (CBT) systems, in which learning resources were depicted as being as atoms or Lego® blocks of content that can be combined or organized to create semantic content. Standards bodies have refined the concept of learning resources into a rigorous form and have provided specifications on how to sequence and organize these bits of content into courses and how to package them for delivery as though they were books, training manuals, or other sources of instructional content.

Electronic instructional content (or “e-learning”) for educational, training, infomercial, or entertainment purposes can be delivered to a user through many media (e.g., the Internet, television, playable storage media, such as videotapes, DVDs, CDs, intelligent tutoring systems, and CBT). The instructional content can be delivered to a user in many different forms (e.g., tests, training programs, and interactive media) and is generally referred to herein as a “course.” In general, e-learning courses are suites of electronic learning resources (i.e., pieces of data that are used in an e-learning course) and can be composed of modules and lessons, supported with quizzes, tests and discussions, and can be integrated into educational institution's student information system, into a business's employee training system, or any other system in which learning occurs. The learning resources of an e-learning course can be composed of numerous files of many different formats (e.g., text files, PDF files, multimedia files, including jpeg, mpeg, wave, and MP3 files, HTML, and XML files). The number and complexity of the different learning resources in a course can be high and the relations and interfaces between the different learning resources also can be complex.

After a course is developed, it is often desired to modify the course and/or to reuse existing learning resources for a new purpose, rather than building a new course for the new purpose from scratch. Therefore, changes have to be made to the learning resources prior to re-use of the content of the learning resources. For example, to alter the content or layout of a course for use in the modified course it can be necessary to modify a learning resource, to segment a learning resource into smaller parts, or to aggregate parts from different learning resources into a new learning resource.

Thus, when it is desired to create a new course from one of several existing courses, it is desirable to start with and modify the course that requires the least amount of modification to achieve the desired result. Various transformations may be required to modify a course, and the various modifications may take different amounts of time or effort to accomplish and therefore result in a different “cost” of modifying the course.

### SUMMARY

In a general aspect, first metadata associated with a first e-learning course are read, the first metadata are compared with metadata associated with a desired e-learning course, a dissimilarity between the first course and a desired e-learning course is determined based on a comparison of the first metadata with metadata associated with the desired course, and a cost of transforming the first course into the desired course is determined.

In another general aspect, an apparatus includes a machine-readable storage medium having executable-instructions stored thereon, and the instructions include an executable code segment for causing a processor to read metadata associated with an e-learning course, an executable code segment for causing a processor to determine a dissimilarity between the course and a desired e-learning course based on a comparison of the metadata with metadata associated with the desired course, and an executable code segment for causing a processor to determine a cost of transforming the course into the desired course.

In another general aspect, a system for estimating evaluating a cost of transforming an existing e-learning course into a desired e-learning course includes a dissimilarity calculation engine operable for determining a dissimilarity between a first existing course of electronic learning resource files and a desired course of electronic learning resource files and a cost calculation engine operable for determining a cost of transforming the first existing course into the desired course.

Implementations can include one or more of the following features. For example, the first metadata can include LOM-standard metadata. Determining the dissimilarity between the first course and the desired course can include calculating a distance vector between the first course and the desired course. A first adaptation tool for performing a transformation on the first course can be determined based on the comparison of the first metadata with metadata associated with the desired course. Determining the cost of transforming the first course into the desired course can include determining a cost of using the first adaptation tool to perform the transformation. Information associated with the first course can be displayed to a user if the cost of transforming the first course is lower than a predetermined value.

A second adaptation tool for performing the transformation on the first course can be determined based on the comparison of the first metadata with metadata associated with the desired course, while a first cost of transforming the first course into the desired course using the first adaptation tool can be determined, and a second cost of transforming the first course into the desired course using the second adaptation tool can be determined. The first cost can be compared with the second costs, and the first or second adaptation tool can be selected for transforming the first course into the desired course based on the comparison.

Second metadata associated with a second e-learning course can be read, a dissimilarity between the second course and the desired course can be determined based on a comparison of the second metadata with the metadata associated with the desired course, and a cost of transforming the second course into the desired course can be determined. Then, the cost of transforming the first course can be compared with the cost of transforming the second course. One or more first transformations needed to transform the first course into the desired course can be determined based on the comparison of the first metadata with metadata associated with the desired course, and one or more second transformations needed to transform the second course into the desired course can be determined based on the comparison of the second metadata with metadata associated with the desired course, where determining the cost of transforming the first course includes determining first constituent costs of performing the one or more first transformations on the first course and where determining the cost of transforming the second course comprises determining second constituent costs of performing the one or more second transformations on the second course. A ranking of the first course and the second course can be displayed to a user based on the costs of transforming the first and second courses, respectively, into the desired course.

The details of one or more implementations are set forth in the accompanying drawings and the description below. Other features will be apparent from the description and drawings, and from the claims.

### BRIEF DESCRIPTION OF THE DRAWINGS

FIG. 1 is a schematic block diagram of a system for determining a cost of modifying an e-learning course.

FIG. 2 is a flow chart of a process for evaluating the cost of modifying an existing e-learning course into a desired course.

FIG. 3 is a schematic block diagram of a framework for modifying an e-learning course.

FIG. 4 is a schematic block of a document object model.

FIG. 5 is a schematic block diagram of a semantic content model.

FIG. 6 is a schematic block diagram of a plug-in module.

FIG. 7 is a flowchart of a process for modifying an e-learning course.

FIG. 8 is a flowchart of a process for modifying an e-learning course.

### DETAILED DESCRIPTION

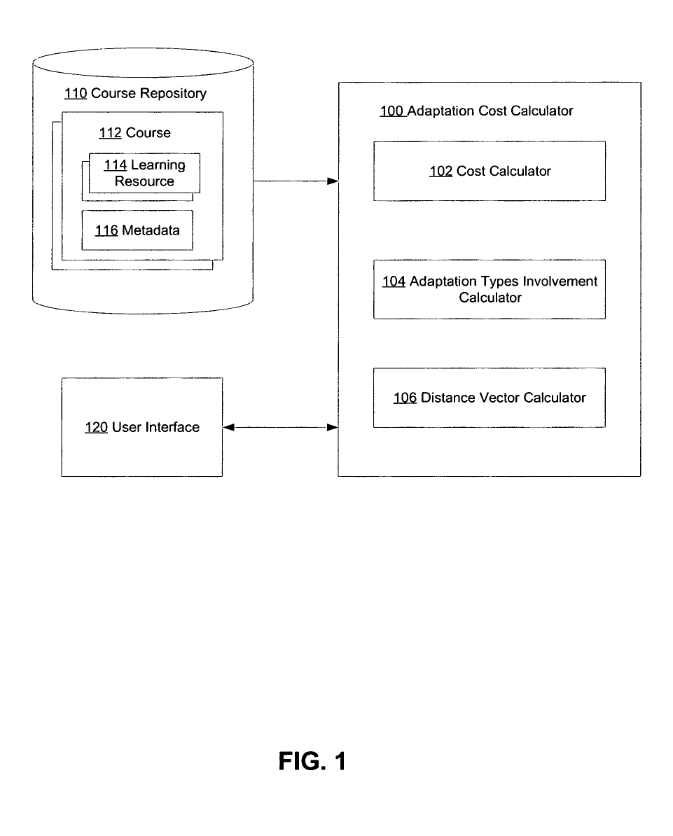

FIG. 1 is a schematic block diagram of a system for determining a cost of modifying an e-learning course. As described herein, an e-learning course 112 includes content composed of various learning resources 114. “Content,” as used herein, refers to both the data and the semantic content in the learning resources. The learning resources 114 can be contained in files or “documents” of many different types, including, for example, text, graphics, photos, animation, simulation, audio, and video, and many be stored in a variety of different formats (e.g., PDF, MPG, JPG, AVI, CSS, DOC, GIF, HTML, MIDI, MP3, MOV/QT, PNG, RAR, TIFF, TXT, WAV, BIN, CSS, PPT, XLS, and ZIP). Documents can be sub-divided into modules, although a document itself can be a module, and a course 112 can consist of a collection of different learning resources 114.

Each course 112 also includes metadata information 116 that can be used to identify pertinent characteristics of the course. For example, the metadata can include information about the semantic density of the course, about the target age of users of the course, about the language(s) used in course content, about the duration of the course, about the educational objective of the course, and about the author(s) of the course. Although particular formats of metadata can be used to characterize the course and the content of the course (e.g., Learning Object Model metadata), metadata information can be any information used to characterize the course and/or content of the course. Metadata fields and values for one exemplary course could be represented by the information in Table 1 below.

TABLE 1

| METADATA FIELD | VALUE |
|---|---|
| EDUCATIONAL OBJECTIVE | TCP/IP |
| SEMANTIC DENSITY | HIGH |
| DURATION | SIX HOURS |
| TARGET AGE | OVER 21 |
| AUTHOR | XYZ CORPORATION |
| LANGUAGE | ENGLISH |

One or more courses 112 can be stored in one or more course repositories 110, from which learning resources 114 and/or metadata 116 associated with the course can be retrieved by an adaptation cost calculator 100 for analysis to determine a cost of adapting one or more courses 112. A user interface 120 allows a user to interact with the adaptation cost calculator to start and/or guide the analysis of the adaptation cost determination.

When the user desires to calculate the cost of adapting an existing course 112 for a new purpose or to create a new course, the user can input a requirements profile characterizing the desired course into the adaptation cost calculator 100 through the user interface 120. The requirements profile can include metadata values that would characterize the desired course. For example, if the user desired a four-hour long course targeted to adults about TCP/IP with high semantic content written in German by the XYZ Corporation, the requirements profile for the desired. course could include the metadata values listed in Table 2 below.

TABLE 2

| METADATA FIELD | VALUE |
|---|---|
| EDUCATIONAL OBJECTIVE | TCP/IP |
| SEMANTIC DENSITY | HIGH |
| DURATION | FOUR HOURS |
| TARGET AGE | OVER 21 |
| AUTHOR | XYZ CORPORATION |
| LANGUAGE | GERMAN |

The information in the requirements profile then can be compared to information characterizing one or more existing courses to determine a degree of dissimilarity between the one or more existing courses and the desired course. When comparing the information characterizing the desired course and the one or more existing courses, normative information, rather than descriptive information, should be used to make the comparison, so that a quantifiable comparison can be made. Thus, strictly formalized metadata should be used when metadata are used to characterize the existing and desired courses. For example, in the Learning Object Metadata (LOM) standard that is sometimes used to characterize learning resources 114, the typical target age range metadata field used to describe the age range of the intended learner requires character strings as input. Thus, it is possible to have values of “over 21” and/or “suited only for adults,” which, although perhaps intended to convey the same information, may not be comparable because of their different formats, and therefore are not suited for a dissimilarity measurement between an existing course and a desired course. Therefore, the existing and desired courses should be characterized using normative specifications (e.g., metadata) of learning resources, for example, as described by Salvador Sánchez-Alonso and Miguel-Angel Sicilia, “Normative Specifications of Learning Objects and Learning Processes: Towards Higher Levels of Automation in Standardized e-Learning,” International Journal of Instructional Technology & Distance Learning, ISSN-1550-6908, vol. 2, no. 3 (March 2005), which is incorporated herein by reference for all purposes.

Once a requirements profile for the desired course has been defined, it can be compared in the distance vector calculator 106 to the information 116 associated with one or more existing courses 112 to determine a degree of dissimilarity between the desired course and the one or more existing courses. The distance vector calculator 106 calculates a metadata distance vector by comparing all metadata of the requirements profile with the corresponding metadata of the existing course 112 that is proposed to be modified. To perform the calculation, the distance vector calculator 106 calculates the dissimilarity between the values for each metadata field of the requirements profile and values of the metadata fields in the existing course. The result of the calculation is a distance vector (e.g., a 1×N vector, when N metadata fields are compared) that lists dissimilarity values for each of the metadata fields.

The range of values for the distance vector entries depends on the type of metadata. For some metadata fields (e.g., the language field) a binary value can be used, such that if the language specified by the requirements profile is different from the language of the existing course a “1” is entered in the distance vector, but if the languages are identical a “0” is entered. For other characteristics of a course that can vary more or less continuously (e.g., semantic density), a comparison of the metadata values in the requirements profile of the existing course and in the desired course can yield an entry in the distance vector that can assume a continuous range of values. For still other characteristics of the course, if the associated metadata values are too different, it may be impossible to adapt the existing course 116 into the desired course, and in such cases the value of the resulting entry in the distance vector is set to infinity. This might be the case if the learning objectives if the existing course and the desired course are totally different (e.g., the learning objective of the existing course is “Modern Art” and the learning objective of the desired course is “TCP/IP”). However, it is also possible that the learning objectives of the existing and desired course are different, but not totally different, in which case the corresponding entry in the distance vector would have a value between zero and infinity. For example, the learning objective of the existing course could be SMTP, while the learning objective of the desired course could be HTTP. In such cases when the value of the metadata field cannot be strictly formalized natural language processing techniques can be used to identify similarities and/or compatibilities between the values of metadata fields for different courses. Thus, by using natural language processing techniques courses have learning objectives of “Modern Art” and “TCP/IP” could be determined to be completely incompatible, while courses have learning objectives of “SMTP” and “HTTP” could be determined to have a non-infinitesimal similarity and compatibility.

In one example, three courses that match some of the metadata of the requirements profile of a desired course can be compared to the requirements profile of the desired course. The following Table 3 shows the metadata of the three courses.

TABLE 3

| | Lan- | Semantic | Educational | Pub- | Target | |
|---|---|---|---|---|---|---|
| | guage | Density | Objective | lisher | Age | Time |
| Course 1 | English | High | Modern Art | xy AG | College | 4 hrs |
| Course 2 | English | High | TCP/IP | ab | College | 4 hrs |
| | | | | GmbH | | |
| Course 3 | German | Medium | TCP/IP | xy AG | High | 2 hrs |
| | | | | | School | |

When the metadata of the three courses are compared in the distance vector calculator 106 with a requirements profile of a desired course that specifies a two-hour long, English-language course about TCP/IP with a high semantic density targeted to college age students and published by xy AG, the following distance vectors (DV) for the three courses:

$${DV}_{1} \text{:} ( \begin{matrix}0 \\ 0 \\ ∞ \\ 0 \\ 0 \\ 1\end{matrix} ) , {DV}_{2} \text{:} ( \begin{matrix}0 \\ 0 \\ 0 \\ 1 \\ 0 \\ 1\end{matrix} ) , {DV}_{3} \text{:} ( \begin{matrix}1 \\ 0.25 \\ 0 \\ 0 \\ 0.5 \\ 0\end{matrix} ) .$$

To adapt an existing course 112 into the desired course, the existing course 112 must be adapted if it is not a 100% fit with the desired course. For example, to adapt Course 1 into the desired course, the learning objective would have to be changed from Modern Art to TCP/IP, and the duration of the course would have to be shortened from four hours to two hours. To adapt Course 2 into the desired course, the content of publisher ab GmbH would have to be changed to resemble the content of publisher xy AG, and the duration of the course would have to be shortened from four hours to two hours. To adapt Course 3 to the desired course, the language of the course would have to be changed from German to English, the semantic density would have to be changed from medium to high, and the target age of the course would have to be changed from high school age to college age. Each of these changes requires a different type of adaptation of the course content. For example, changing the language requires a translation adaptation; shortening the course from four hours to two hours requires editing of the course content; changing the content to resemble that of a different publisher requires adaptation of the layout and adaptation of the terminology; changing the semantic density of the course requires adaptation of the semantic density; and changing the target age of the course requires adapting the semantic density and adaptation of the terminology.

The distance vector calculator 106 can be customized to accommodate new data types that might be added to an existing or desired course. For example, if a new metadata field is added to the metadata record for the existing or desired course, the new metadata must be account for the new value in the calculation of the distance vector.

The need to perform a transformation of a particular kind on an existing course 112 to adapt the course to the requirements profile of the desired course can be represented in an adaptation type involvement matrix (ATIM). The ATIM is an N×M matrix, where N is the number of different transformations necessary for the adaptation, and M is the number of metadata fields in the requirements profile. Entries in a row of the matrix correspond to different metadata fields, and entries in a column of the matrix correspond to different transformation types. If a difference in the metadata values of the existing course and the desired course leads to the need to perform an adaptation the matrix entry contains “1” otherwise it contains “0.” For example, the adaptation type involvement matrix that would be used to describe the transformations necessary to perform on the existing course, whose metadata are described in distance vectors, DV₁, DV₂, and DV₃, would be:

$$ATIM = ( \begin{matrix}1 & 0 & 0 & 0 & 0 & 0 \\ 0 & 1 & 0 & 0 & 1 & 0 \\ 0 & 0 & 1 & 0 & 0 & 0 \\ 0 & 0 & 0 & 1 & 0 & 0 \\ 0 & 0 & 0 & 1 & 1 & 0 \\ 0 & 0 & 0 & 0 & 0 & 1\end{matrix} ) ,$$

where the entries in a row correspond to, respectively, the metadata fields: Language, Semantic Density, Educational Objective, Publisher, Target Age, and Time, and entries in a column correspond to, respectively, the transformation types: Translation, Semantic Density Enhancement, Educational Objective Adaptation, Layout Adaptation, Terminology Adaptation, and Content Editing. Thus, for example, the fourth column of the ATIM indicates that to adapt the publisher of an existing course requires transforming the layout and the terminology of the course.

The ATIM could be subject to change if either new metadata fields are introduced to the existing or desired course or if the supported adaptation types change in number or definition. The values of the matrix could also be changed based on experience with the adaptation cost calculator 100.

Once the ATIM is generated, it is fed into the adaptation type involvement calculator 104 along with the distance vectors that characterize the degree of dissimilarity between the different existing courses and the desired course. The distance vectors are multiplied by the ATIM, and the result of this multiplication is an “effort vector” for each existing course, which contains information about the estimated effort required to transform the existing course into the desired course. For example, the effort vectors (EV) characterizing the effort required to adapt each of the three existing courses would be:

$${EV}_{1} \text{:} ( \begin{matrix}0 \\ 0 \\ ∞ \\ 0 \\ 0 \\ 1\end{matrix} ) , {EV}_{2} \text{:} ( \begin{matrix}0 \\ 0 \\ 0 \\ 1 \\ 1 \\ 1\end{matrix} ) , {EV}_{3} \text{:} ( \begin{matrix}1 \\ 0.25 \\ 0 \\ 0 \\ 0.5 \\ 0\end{matrix} ) .$$

The effort vector associated with an existing course 112 is input into the cost calculator 102, which runs the elements of the effort vector through a cost function to determine a cost of adapting the existing course to create the desired course. The cost function depends on the tools available to perform the transformation. For example, if a translation tool supports easy automatic translations, the cost function associated with a translation transformation type will return a relatively low cost value for a translation that is required by the effort vector. However, if the translation tool does not support easy automatic translations, or not support automatic translations at all, such that manual translations are required, the resulting cost of the translation will be higher.

In one exemplary implementation, the cost function could consist of multiplying the effort vector by a cost vector that contains a cost value for each adaptation type. The individual costs of each adaptation then would be added to determine a total cost for the adaptation of the existing course into the desired course. The cost value of an adaptation can depend on the tools used for the particular adaptation. For example, if a layout adaptation tool that executes an automatic layout adaptation is used, the cost value for the layout adaptation would be very low. However, if the layout adaptation must be executed completely manually, the cost value for the layout adaptation would be set to a higher value. More complex cost functions can also be implemented. For example, the cost value of a first adaptation can depend on whether a second adaptation is required to achieve the transformation and on the cost value of the second adaptation.

Because each adaptation tool has a characteristic cost function that specifies how efficiently the tool supports a particular adaptation type, the selection of the best-suited tool to perform the adaptation depends on what the user wants to use it for. Therefore, the cost function often will require input from the user to optimize the cost function for an adaptation of an existing course into a desired course. Additionally, if the cost function of an adaptation tool can be determined as result of an application study, this cost function could act as a quality measurement for that particular tool.

Thus, the cost function as applied in the cost calculator 102 calculates an estimated cost, burden, or time, which is required for adaptations of the existing course into the desired course. Estimated costs for adapting different existing courses into a desired course can be compared, so that the existing course that requires the smallest cost for adaptation can be chosen as the starting point from which to develop the desired course. The estimated costs of adapting different existing courses could be calculated, and a rank-ordered list of all, or a selection of the available existing courses could be presented to the user through the user interface 120 in order of the estimated cost of adapting the course.

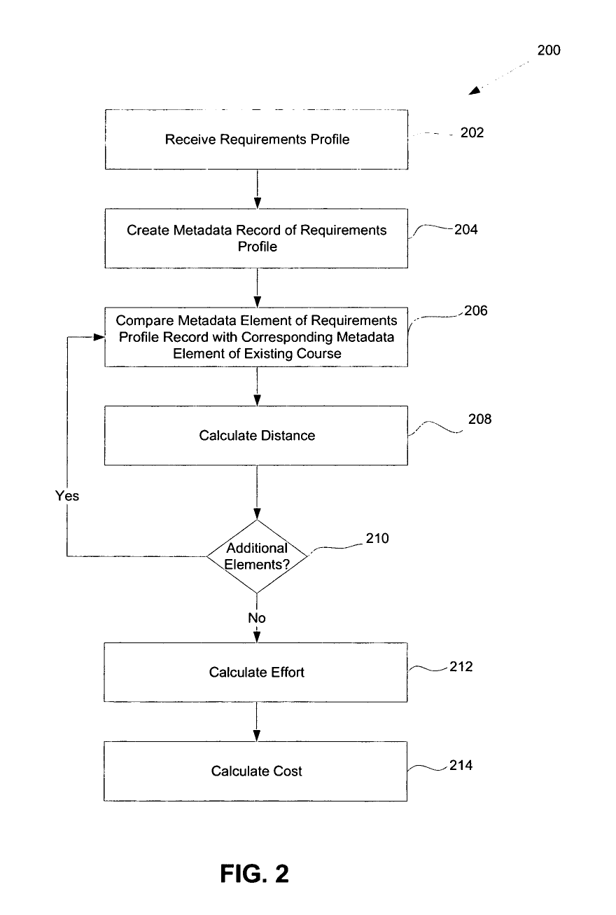

FIG. 2 is a flow chart of a process 200 for evaluating the cost of modifying an existing e-learning course into a desired course. A requirements profile specifying characteristics of a desired course is created, and information in the requirements profile is received (step 202). A metadata record of the requirements profile is created (step 204) using a formalism for the metadata that is consistent with the formalism of metadata used to characterize the existing e-learning course. Then, metadata elements of the requirements profile metadata record are compared with corresponding elements of the metadata record for the existing e-learning course (step 206), and a distance between the elements is calculated (step 208). If additional elements in the metadata record of the requirements profile exist (decision 210), then the comparison and distance calculation steps are repeated. In this manner, a dissimilarity between the existing e-learning course and the desired e-learning course is determined based on a comparison of the first metadata with metadata associated with the desired course. After distances have been calculated for all metadata elements, the effort required to transform the existing course into the desired course is calculated (step 212). For example, the individual transformations necessary to perform the total transformation of the existing e-learning course can be determined. After the effort has been calculated, the cost of transforming the existing course into the desired course is calculated (step 214).

In one exemplary implementation of a system for transforming an existing e-learning course into a new course, content of an existing e-learning course can be represented in three layers: the physical files of the learning resources, which are stored in a storage medium; a tree-like object-oriented model representing the structures of the learning resources (e.g., a tree of java objects for a document model); and a semantic model that contains an outline of the content including semantic relations and decoration (e.g., a Resource Description Framework (“RDF”) model for a semantic model of the content). The models are sequentially built in a bottom-up approach. Thus, the object model is built by reading learning resource documents or modules from a storage device and creating an object tree from the content in the documents or modules. The semantic model is built based on the object model and provides information about the semantic content of the course to a user. Once the user selects a course to modify, the user can analyze the semantic content model of the course and make modifications that are implemented as modifications within the object model. The modifications to the object model then are propagated to the learning resource modules stored on the storage device.

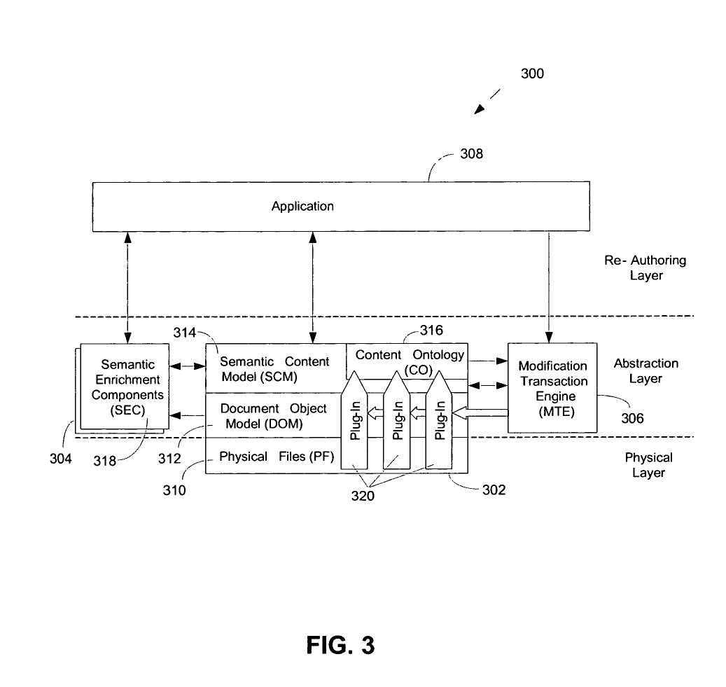

FIG. 3 is a block diagram of a framework 300 for organizing, analyzing, and re-authoring an e-learning course composed of learning resources. The framework 300 is organized in three main blocks: a content model block 302, a semantic enrichment block 304, and a Modification Transaction Engine (“MTE”) 306. An application layer 308 through which a user can access the learning resources and representations of the learning resources communicates with the three blocks 302, 304 and 306 to allow the user to perform different tasks. The content model block 302 can be used for analysis of the content of the course. The semantic enrichment block 304 is used for controlling the level of detail in the content model. The MTE 306 can be used to modify the content in the course.

The content model block 102 can be divided into three layers: a physical files (“PF”) layer 310, a document object model layer (“DOM”) 312, and semantic content model layer (“SCM”) 314, which are stacked one on top of the other within the framework 300. The physical files layer 310 can be responsible for handling access to the physical files and directories of the learning resources (e.g., the HTML, PDF, TXT, MPG, JPG, etc. files that contain the content of the course). This includes access to the file system, working with the directory structure, as well as reading and writing files. Format plug-ins, as described below, may add support for modifying files on disk to the PF layer 310.

The DOM 312 is an object-oriented model that contains an outline (e.g., an object tree) that is created based on the structure of the documents in the physical files layer 310. After the object tree is created, the tree is transferred to the semantic content model 314, in which entities within the semantic model are marked so that they can be uniquely mapped to the entities of the DOM 312. Thus, the SCM 314 is a more abstract representation of the course content, containing only selected parts of the DOM structure but enriched with explicit semantic and didactic information about the content. The SCM 314 is complemented by a content ontology (“CO”) 316 that provides conceptual knowledge about the used types of entities and relations.

The semantic enrichment block 304 contains one or more semantic enrichment components (“SEC”) 318, which analyze the semantic content model 314 in order to make implicit semantics explicit to the semantic content model 314. An SEC 318 may also use and add external knowledge to fulfill this task. Thus, semantic relations can be added to the semantic content model 314 both during the conversion and afterwards as a result of a more intensive content analysis. The semantic content model 314 is then ready to be used for an analysis of the content.

After analysis of the semantic content model 314, a user can choose to modify the content of the e-learning course. The user may have selected a particular e-learning course from several available courses to adapt into the desired new course based on a calculation of the cost of adapting the course that indicates that the particular course requires the lowest cost to modify. However, the semantic content model 314 is only an incomplete outline of the whole content of the course, and because intended modifications to the semantic content may have different results on the content in the physical file layer 310 depending on the target document's format, modifications are carried out generally in the DOM 312. Because the DOM 312 is an outline of the complete content of the course, the DOM 312 has read-write access to the physical files of the learning resources, and can handle format-specific data modifications where required, modifications to the format-independent DOM 312 result in modifications to the format-dependent learning resources within the physical file layer 310.

Thus, the application layer 308 can analyze the content through the semantic model 314, but the content is modified through the object model 312. Therefore, a mapping from the entities of the semantic content model 314 to the entities of the document object model 312 is necessary, as described below.

Modifications to a course (e.g., a translation, an enrichment of semantic content, an adaptation of the layout or terminology used in the course) can be invoked by the application layer 308 as atomic modification transactions, where each modification is specified as a tuple that contains the type of modification, the target element(s), and optional additional arguments. These modifications are handled by a dedicated modification transaction engine 306 that maps the transaction to the intended target objects in the DOM 312 and finally invokes the correct object methods. When a transactional modification has been performed successfully, the semantic model might need to be refreshed to account for new semantic content in the course.

The content model block 302 also includes format-dependent plug-in modules 320 that read and write between the content stored in learning resources in a particular format in the physical files 310 and the format-independent DOM 312 and the SCM 314. For each format that is to be supported, a plug-in 320 is provided, and the plug-ins contain the code to read, write, and modify its particular physical document format. Furthermore, the plug-ins 320 provide class definitions that extend the document model's base classes and an extension to the semantic model's ontology.

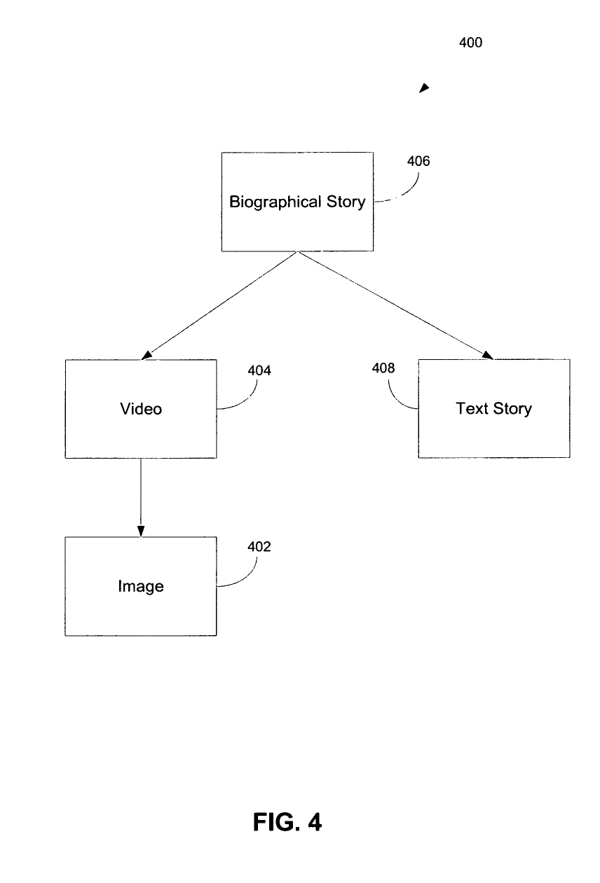

Referring to FIG. 4, the DOM 312 can be a tree-like object-oriented representation 400 of the content in the learning resources of a course. The learning resources can be stored in the form of generic documents, and for each document that belongs to the content, a new partial DOM (“pDOM”) can be created. These pDOMs are then joined to one single DOM by adding references from a sub-document's pDOMs to a parent document's pDOM. That is, the content DOM is a tree which consists of sub trees for the particular documents. Thus, a pDOM 402 that relates to an image of a person can be a sub-document of a pDOM 404 that relates to video footage of the person, which, in turn, can be a sub-document of a pDOM 406 that relates to a biographical story about the person. Additionally, a document containing textual information about the person can be a pDOM 408 of the pDOM 406. Together, pDOM's 402-408 can be joined in a tree 400 as a single DOM that relates to a multi-media biography about the person.

Metadata can be associated with the documents containing the content of the learning resources and used to structure the document object model 400. For example, metadata according to the Learning Object Metadata (LOM) standard can used to describe aspects of the learning resources. Thus, metadata can be used to store standard information about a learning resource's language, publication date, author, title, description, keywords, etc. and the DOM 400 and the pDOMs 402-408 can be built from the metadata.

In one example, documents formatted in IMS Content Packaging (IMS-CP), HTML, and JPEG can store the content of learning resources of a course. In the IMS-CP protocol, a Content Package is a compressed file (usually a zip file) that contains the learning object, its metadata record, and a manifest describing the contents of the package. The document object model 400 for IMS-CP documents can consist of Java classes and objects, in which the generic DOM 400 is built out of a set of pDOM java classes that represent standard types of document fragments and structural elements such as “TextFragment,” “StructuralElement,” “Title,” or “Image.” These java classes can be extended to include additional classes. For example, for representing IMS-CP documents, a class “OrganizationItem” can be defined and used to refer to documents relating to organizational content of a course (e.g., terminology used in the course, target age for users of the course, language of the course content), thus extending the “StructuralElement” class. Instances of the OrganizationItem class can be instantiated at run-time to represent structural items of the content package's manifest. The manifest itself can be an XML file, which can be read into memory by a standard XML-DOM library. Each instance of the class “OrganizationItem” therefore contains a reference to the corresponding standard DOM object. The data are stored primarily in the XML-DOM, and the CP objects provide only a view of the XML-DOM to simplify the access to the data. CP objects contain mainly getter/setter methods as well as special methods to access subordinated or referencing objects. In addition, the CP objects can work as a cache to accelerate access to the data. For example, an object “CPOrganization” can be assigned to an “OrganizationItem” element of the XML-DOM. The CPOrganization object permits the reading and writing of the “StructuralElement” and “Title,” attributes, produced by requests from a list of the subordinate “Items” objects and can insert new items.

Similarly, for HTML document, generic content classes can be extended to suit the particularities of HTML. For example, there may be an “HTMLTitle” class which extends the “TextFragment” element and represents the <title>-element of an HTML document. In the background a standard HTML-DOM is used for reading and writing the document.

For the JPEG documents, each image can be represented as one single object, and the image object's methods can allow access to the extracted metadata of that image.

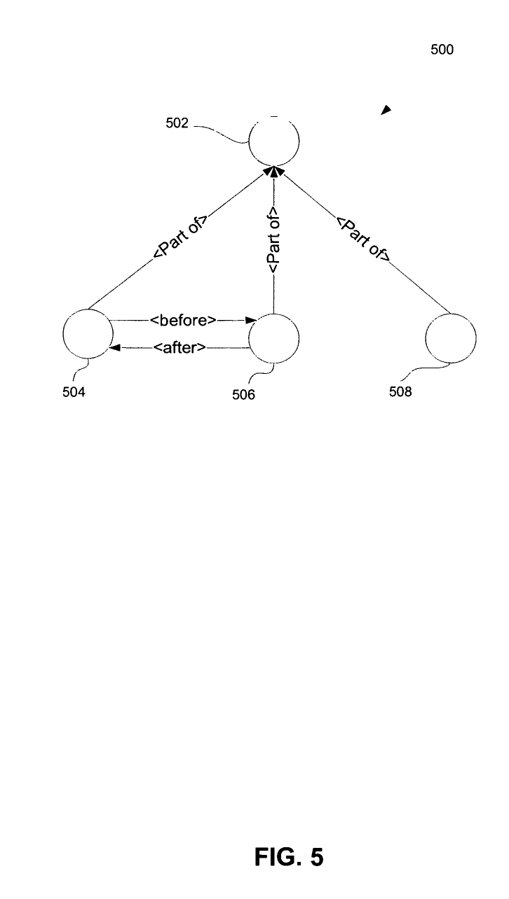

Referring to FIG. 5, the semantic content model is an abstract representation of the content of the learning resources and includes interfaces to search and access semantic information about content parts of the learning resources. The SCM itself is described by a directed graph with typed relations. For example a Resource Description Framework model can be used for the SCM, because the RDF model permits creation of graphs that consists of typed nodes and relations. Multiple classes may be assigned to one node, such that the different meanings or roles of an individual content element can be expressed within the node.

As shown in FIG. 5, a base SCM graph 500 can be automatically constructed from the DOM and contains nodes 502, 504, 506, and 508 that reference each document object in the DOM as well as a relation of the type “part of” to the root node 502 of the graph, which provides an enclosing container for the whole content. A “before” and “after” relation is inserted between content nodes to refer to the sequential information of the content. For example, node 504 contains a “before” relation to node 506, and node 506 contains an “after” relation to the node 504 to indicate that semantic content identified in the node 504 comes sequentially before the semantic content identified by node 506 in the course described by the graph 500. Each node is marked with a unique identifier that references the underlying document object in the DOM. RDF libraries often contain their own query language such as RQL, RDQL or SeRQL, which are suited for analysis of the SCM.

The document object model 312 is transformed into the semantic content model by rebuilding (parts of) the structure of the DOM in the RDF model used for the SCM 314 by mapping Java objects to RDF entities. The mapping algorithm starts with the top level element 402 of the DOM tree 400. This entity is assigned a type out of the content ontology 316 that corresponds to the Java object's class. Additionally, attributes of the Java object may be copied to the SCM as properties.

During the transformation from the DOM to the SCM, each Java object can checked for its relevance in the SCM by looking up the particular class in a black list, which is used in the application layer 308 to reduce the size of the SCM 314 by excluding certain object types from being converted to the SCM. If the object is considered relevant, an RDF entity corresponding to the Java object is created in the SCM. For example, in an application that translates a course from one language to another text and markup content need to be analyzed but images are not necessary. Hence, the image class can be placed on the black list, and image data will not be copied to the SCM, which thereby becomes smaller.

Each RDF entity in the SCM has a unique identifier, and, to map the RDF entry back to the Java object later, the entity's identifier and a reference to the Java object are stored in a hash table, using the identifier as key. The hash table is accessible by the Modification Transaction Engine 306. By reading all relevant tree nodes of the DOM 312, the DOM's structure is copied to the SCM 314. References from each RDF entry to the corresponding Java object are available in a hash table.

Knowledge about common content structure or didactical approaches is stored in several ontologies in the content ontology module 316. Additional format-dependant knowledge about the content can be added to the CO module 316 by the plug-ins that access content stored in particular formats in the physical file layer 310. For example, a plug-in for the PowerPoint format of learning resources knows that a presentation may include a slide master that typically holds layout information and can communicate this knowledge to the CO module 316. Such information may be relevant when pertaining to modification of the layout of the course (e.g., from a PowerPoint layout to a PDF layout).

The Content Ontology can be specified in the OWL Web Ontology Language because in OWL, classes and relation types can be defined for use within an RDF model. With the help of reasoners or inference machines, new information can be deduced from an RDF model and imported into the Content Ontology module 316. For each class of the Java DOM, a corresponding class can be specified in OWL. Additional classes are specified to express semantic information.

With the aid of the CO module 316 and a Reasoner, one or more semantic enrichment components 318 can add new node information or relations to the SCM 314. For semantic analysis and enhancement of the content, one or more SECs 318 can be integrated with the application layer 308 and with the content model block 302. A SEC analyses either the document object model 400 or the semantic content model 300 to gain information about semantic information in the course. This information may either be implicit semantics, which is simply transferred into explicit knowledge, or new semantics that are derived from the content with the help of additional external information sources.

An SEC 318 can be a Java object that has access to the Java document object model 312 and to the RDF semantic content model 314. For accessing the RDF semantic content model 314, the SEC 318 can use either an RDF query language or direct access to the RDF library. The SEC 318 analyzes either both models or only one of them and finally adds a set of statements to the RDF graph in the semantic content model 314. The SEC can update and enrich the SCM 314 by adding the identified semantic information to the SCM by adding relations to the graph and adding additional information to the content nodes 502-508.

For example, when a user wants to modify a course by translating its content into a different language, the user may want to know the language of text fragments and also have quotations marked, so that direct quotations will remain in their original language in spite of the translation modification. Two separate SECs can be designed for performing the tasks of identifying and marking the language of text fragments and for locating quotations in the text, so that they can be re-used independent from each other for other applications. The first SEC is responsible for determining and marking the language of text fragments. It requests all text fragments from the SCM and, based on comparisons to dictionaries of different languages it decides which language each fragment most probably belongs to. The text fragment entity is marked by adding a language property to the text fragment in the SCM 314. The second SEC identifies quotations inside text fragments. This component requests all text fragments and analyzes them. Multiple indicators can be used for recognizing quotations, for example, the explicit usage of markup such as the <q> and <blockquote> tags in HTML can be used. Another indicator is the use of quotation marks, although this one is less reliable. To all identified text entities in the SCM 314 a type “Quotation” can be added in the SCM.

Modifications to the content of a course are carried out through the Modification Transaction Engine 306. Because the semantic content model 314 is a graph that represents the content of the course in an abstract way it does not contain all information that is available on the lower abstraction layers (e.g., the DOM 312 and the PF layer 310). The SCM 314 is optimized for analysis, but modifications can not be performed directly on this model. Therefore, all modifications have to be passed to the DOM-layer 312 and, respectively, to the format plug-ins 320 for execution in the physical file layer 310. The modification transaction engine MTE 306 serves as a consistent interface between the SCM 314 and the PF layer 310.

The MTE 306 accepts modification commands in the form of tuples that represent transactional modifications on the data object model 312. The complexity of a transaction may vary from simple modifications such as a permutation of structural nodes or the change of a node's attribute to complex modifications such as the translation of text.

A command tuple can include command identifiers, content node identifiers, and simple data values. A command identifier can specify the command type, i.e., what the command executer is supposed to do. The targets of a command can be specified by node identifiers that allow a unique mapping from SCM entries and instances in the document object model 312. Simple data values, such as strings, integers, or floating point numbers can be used as additional arguments.

Several examples of valid commands could be: (CMD_DELETE, 376), which would delete the node with identified as (RDF-)ID 376; (CMD_MOVE, 13, 412), which would relocate the node 13 to a location below node 412; (CMD_REPLACE_TEXT, 14, “new text”), which would change the text of node 14 with the string, “new text”; and (CMD_REPLACE_Image, 32, “c:/images/new_image.jpg”), which would replace the image node 14 by a new image that has to be copied from the file identified as “c:/images/new_image.jpg.” Thus, the MTE 306 is responsible for mapping the given node identifiers in the SCM 314 to the corresponding objects in the DOM 312, mapping the given command identifiers to object methods, converting the arguments (content nodes and simple values) to match the methods' signatures, and calling the object methods that perform a transaction execution.

The Modification Transaction Engine (MTE) 306 can be implemented as a Java component that accepts modification commands as method calls. This method may have a signature such as modificationCommand(List command), where the command list contains the values of a command tuple. Command identifiers are expressed constants, entity identifiers as URI strings. The MTE has access to a hash table where the Java object in the DOM corresponding to each entity in the SCM is stored. When the MTE is given a command it first resolves the entity identifiers into Java object references. Then it identifies the object whose method has to be called to execute the command. For example, the command (CMD_REPLACE_TEXT, 14, “new text”), which issues an instruction to replace the text in node 14 with the text “new text,” would be transformed into (CMD_REPLACE_TEXT, <java_object_x>, “new text”) first. Because the MTE knows the command template for ‘CMD_REPLACE_TEXT’, it identifies <java_object_x> as the object in charge and the given string “new text” as single argument for the object's method replaceText. This method replaceText is finally called with the call “java_object_x.replaceText (“new text”).”

Some modifications commands are available for all format types; others are valid only for particular formats. Hence, each submitted command has to be checked against the involved plug-ins' capabilities to determine whether the command is supported or not.

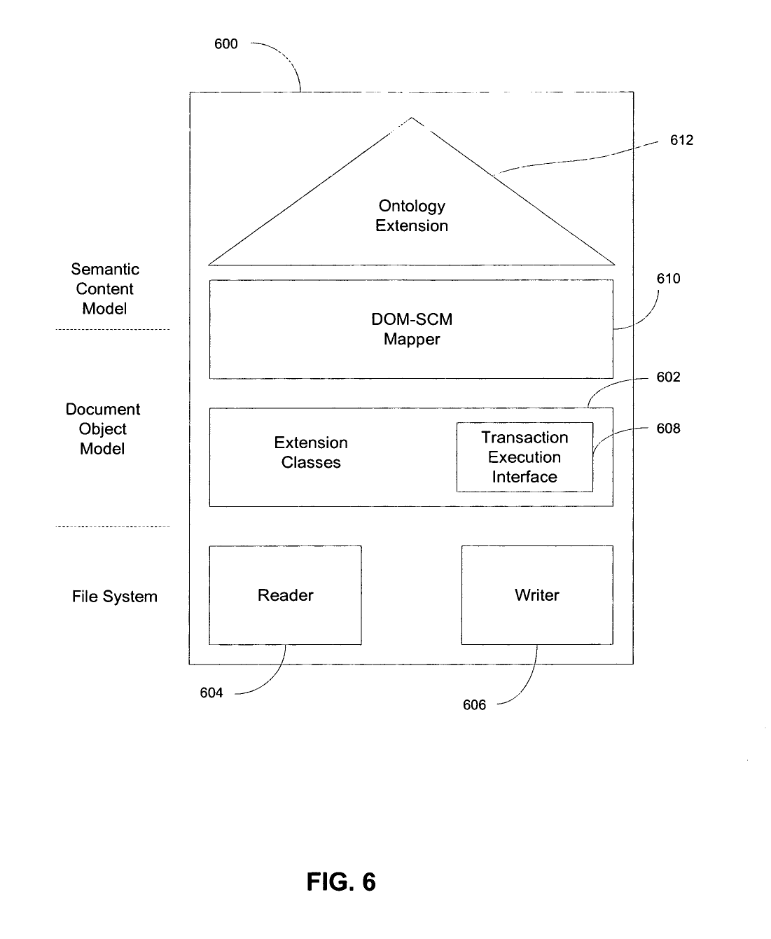

While the components of the SCM 314 and the DOM 312 are designed to work in a format-independent manner, format-plug-ins 320 are used to add format-specific functionality to the framework 300. Referring to FIG. 6, a plug-in 600 can include an extension of the model classes, code for transformations between the model layers and code for transaction execution. Thus, components of a format plug-in can include: DOM Extension Classes 602; a Document Reader 604; a Document Writer 606; a Transaction Execution Interface (TEI) 608; a DOM-to-SCM Mapper 610; and a Content Ontology Extension 612.

DOM Extension Classes 602 are classes that are used to build a document object model 400 from a document in a particular document format. These classes though should implement generic interfaces, so that the framework 300 can access generic methods on them.

The Document Reader 604 is a module that reads all required data from a file to build a DOM 400. Thus, the Reader (or parts of it) may also be part of the DOM Extension Classes. For the opposite direction, i.e., writing information to the storage medium on which the learning resources are stored, a Document Writer 606 is used. The Document Writer 606 need not write a complete DOM to disk, but can also modify a portion of a file directly on disk, which can result in more efficient performance, especially for large files.

Another part of a plug-in is the Transaction Execution Interface (TEI) 608. A TEI is typically embedded in the DOM Extension Classes 602; it handles all modification transaction commands that affect elements of the particular format. The tasks of the TEI include: providing information about available modification methods to the MTE; checking if a particular command is supported; and redirecting modification method calls to the appropriate internal methods.

How a modification is handled inside the plug-in 600 is transparent to the remaining system. The TEI 608 takes all modification transactions and hands them over to internal methods. Modifications may be processed either by the DOM 312 in main memory, or by the document writer 606 by changing the data on storage medium.

The content ontology for the semantic content model can be extended by format-specific add-ons n the ontology extension 612. This includes new or extended types, as well as additional attributes and relations that are special to the particular format. Furthermore, inference rules for the extended ontology may be added.

Furthermore, the DOM-to-SCM Mapper 610 is a component for rendering a document object model 312 into the corresponding semantic content model 314. The Mapper 410 is controlled by a configuration that influences, for example, which entities of the DOM are mapped to the SCM, which attributes of the entities are mapped to the SCM, and which additional implicitly-known information is added to the SCM. Especially for large files, a reduction to a small subset of data can be helpful for fast processing. The mapping configuration in the Mapper 610 is specified at run-time, so that an application can align the model mapping with its current task.

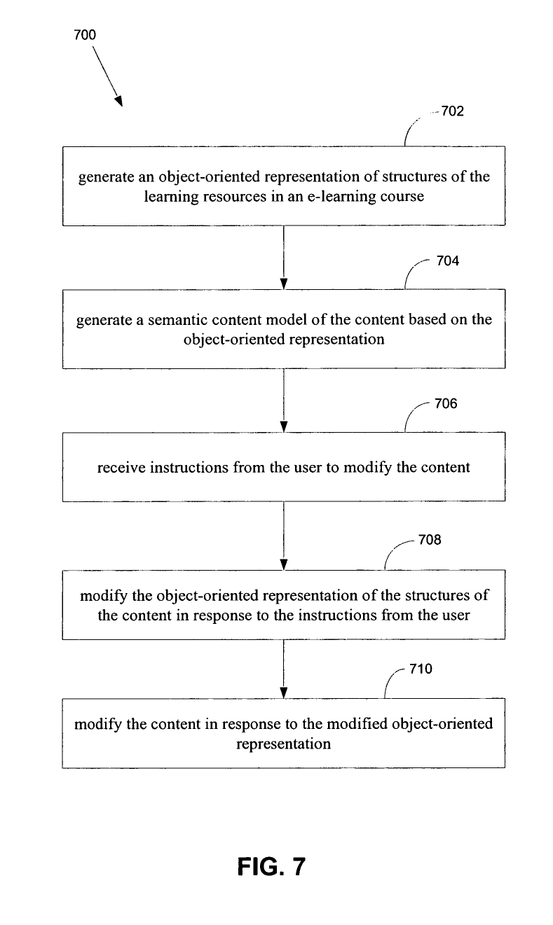

Referring to FIG. 7, the framework 300 can be used in a process 700 for modifying the content of an e-learning course. In the process, an object—oriented representation of structures of the content in an e-learning course are generated (step 702), and a semantic content model of the content is generated based on the object-oriented representation (step 704). Thereafter, the semantic content model is analyzed (step 706) and instructions are received from a user to modify the content (step 708). The object-oriented representation of the structures of the content is modified in response to the instructions from the user (step 710), the content in the e-learning resources is modified in response to the modified object-oriented representation of structures of the content (step 712).

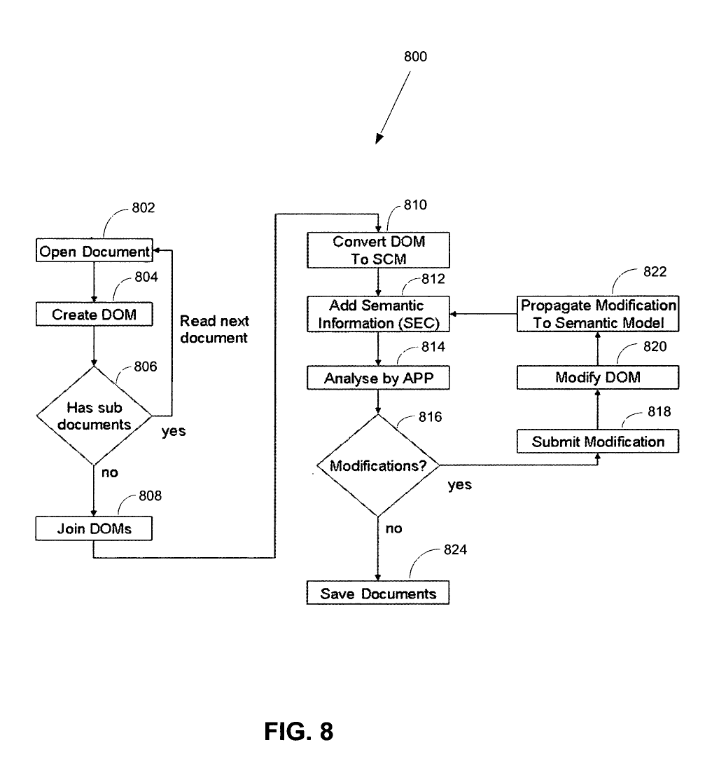

Referring to FIG. 8, a process 800 shows how the processes described in reference to FIG. 7 can be described in terms of several smaller processes. The process begins with reading the top level document of the e-learning course (step 802). This document is parsed and a partial DOM is created (step 804). If the document refers to a sub-document (query 806), for each reference to further included documents, this process of building a pDOM is repeated for each of the sub-documents. After all documents have been read, the individual pDOMs are joined to a single DOM by linking the various object trees to each other (step 808).

The document object model is then transferred to the SCM by copying desired nodes and the belonging connections from the DOM-tree to the SCM-graph (step 810). Thereafter, an analysis is performed by semantic enrichment components to insert additional information into the graph (step 812). After this process, the document object model and the semantic content model are complete and can be analyzed to analyze the content of the e-learning course.

The application has access to the SCM and may perform an analysis of the content (step 814). To add content or structural information to the SCM, the application can make use of one or more SECs. If a modification to the learning resource is desired (query 816), the application submits modification transaction commands (step 818). These commands are then executed on DOM-level and result in a changed document object model (step 820). The changes are also propagated to the semantic model (step 822). In some cases, semantic information that was previously added to the SCM must be recalculated after the modification. Once the modifications are applied to both the DOM and the SCM, the application may start to analyze the content again (step 816).

If no further changes are desired (query 818), the changed documents are saved (step 824) and the program quits.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
reading first metadata associated with a first e-learning course;
comparing the first metadata with metadata associated with a desired e-learning course;
determining a dissimilarity between the first course and the desired e-learning course based on the comparison of the first metadata with metadata associated with the desired course; and
determining a cost of transforming the first course into the desired course.

2. The method of claim 1, wherein the first metadata comprises LOM-standard metadata.

3. The method of claim 1, wherein determining the dissimilarity between the first course and the desired course comprises calculating a distance vector between the first course and the desired course.

4. The method of claim 1, further comprising determining, based on the comparison of the first metadata with metadata associated with the desired course, a first adaptation tool for performing a transformation on the first course.

5. The method of claim 4, wherein determining the cost of transforming the first course into the desired course comprises determining a cost of using the first adaptation tool to perform the transformation.

6. The method of claim 4, further comprising:
determining, based on the comparison of the first metadata with metadata associated with the desired course, a second adaptation tool for performing the transformation on the first course; and
determining a first cost of transforming the first course into the desired course using the first adaptation tool;
determining a second cost of transforming the first course into the desired course using the second adaptation tool.

7. The method of claim 6, further comprising:
comparing the first cost with the second costs; and
selecting the first or second adaptation tool for transforming the first course into the desired course based on the comparison.

8. The method of claim 1, further comprising displaying to a user information associated with the first course if the cost of transforming the first course is lower than a predetermined value.

9. The method of claim 1, further comprising:
reading second metadata associated with a second e-learning course;
determining a dissimilarity between the second course and the desired course based on a comparison of the second metadata with the metadata associated with the desired course;
determining a cost of transforming the second course into the desired course; and
comparing the cost of transforming the first course with the cost of transforming the second course.

10. The method of claim 9, further comprising:
determining, based on the comparison of the first metadata with metadata associated with the desired course, one or more first transformations needed to transform the first course into the desired course; and
determining, based on the comparison of the second metadata with metadata associated with the desired course, one or more second transformations needed to transform the second course into the desired course,
wherein determining the cost of transforming the first course comprises determining first constituent costs of performing the one or more first transformations on the first course; and
wherein determining the cost of transforming the second course comprises determining second constituent costs of performing the one or more second transformations on the second course.

11. The method of claim 9, further comprising displaying to a user a ranking of the first course and the second course based on the costs of transforming the first and second courses, respectively, into the desired course.

12. An apparatus comprising a machine-readable storage medium having executable-instructions stored thereon, the instructions including:
an executable code segment for causing a processor to read metadata associated with an e-learning course;
an executable code segment for causing a processor to determine a dissimilarity between the course and a desired e-learning course based on a comparison of the metadata with metadata associated with the desired course; and
an executable code segment for causing a processor to determine a cost of transforming the course into the desired course.

13. The apparatus of claim 12, wherein the metadata comprises LOM-standard metadata.

14. The apparatus of claim 12, wherein the instructions further include an executable code segment for causing a processor to display to a user information associated with the course if the cost of transforming the course is lower than a predetermined value but not to display to the user information associated with the course if the cost of transforming the course is greater than the predetermined value.

15. The apparatus of claim 11, wherein the instructions further include an executable code segment for causing a processor to display to a user information associated with the course if the cost of transforming the course is lower than a cost of transforming another course into the desired course but not to display to the user information associated with the course if the cost of transforming the course is greater than a cost of transforming another course into the desired course.

16. A system for estimating evaluating a cost of transforming an existing e-learning course into a desired e-learning course, the system comprising:
a dissimilarity calculation engine operable for determining a dissimilarity between a first existing course of electronic learning resource files and a desired course of electronic learning resource files; and
a cost calculation engine operable for determining a cost of transforming the first existing course into the desired course.

17. The system of claim 16, wherein the dissimilarity calculation engine is operable for determining the dissimilarity based on metadata associated with the first existing course and metadata associated with the desired course.

18. The system of claim 16, further comprising an adaptation type calculation engine operable for determining types of adaptations to be used for transforming the first existing e-learning course into the desired e-learning course.

19. The system of claim 16, wherein the cost calculation engine is operable for determining costs of transforming the first existing course into the desired course using different transformation tools to perform a particular transformation.

20. The system of claim 16,
wherein the dissimilarity calculation engine is further operable for determining a dissimilarity between a second existing e-learning course and the desired course; and
wherein the cost calculation engine is further operable for determining a cost of transforming the second existing course into the desired course.
